(19) United States
(12) Patent Application Publication
(10) Pub. No.: US 2011/0062904 A1
(43) Pub. Date: Mar. 17, 2011

(54) ALTERNATING CURRENT MOTOR CONTROL SYSTEM

(75) Inventor: Tsuneyuki Egami, Gamagori-city (JP)

(73) Assignee: DENSO CORPORATION, Kariya-city (JP)

(21) Appl. No.: 12/877,305

(22) Filed: Sep. 8, 2010

(30) Foreign Application Priority Data
Sep. 11, 2009 (JP) 2009-210096

(51) Int. Cl. H02P 6/16

(52) U.S. Cl. 318/400.04

(57) ABSTRACT

An alternating current motor control system includes a three-phase synchronous alternating current motor, a rotational position sensor, and a motor control portion. The three-phase synchronous alternating current motor includes a rotor. The rotational position sensor detects a rotational position of the rotor. The motor control portion digitizes a detection signal of the rotational position sensor into a rotational position signal with a resolution that a quotient when an electrical angle of 360 degrees is divided by a multiple of 3 is set to a quantization unit. The motor control portion performs a rectangular wave control of applying a rectangular wave voltage based on the rotational position signal so that an energizing current of the three-phase synchronous alternating current motor is commutated every electrical angle of 60 degrees.

### CROSS REFERENCE TO RELATED APPLICATIONS

The present application is based on and claims priority to Japanese Patent Application No. 2009-210096 filed on Sep. 11, 2009, the contents of which are incorporated in their entirety herein by reference.

### BACKGROUND OF THE INVENTION

1. Field of the Invention

The present invention relates to an alternating current motor (AC motor) control system.

2. Description of the Related Art

On an electric vehicle and a hybrid vehicle, an AC motor is mounted as a driving source. A motor control system of the electric vehicle and the hybrid vehicle includes a three-phase synchronous AC motor and a rotational position sensor for detecting a rotational position of a rotor of the AC motor. The motor control system controls voltages applied to respective phases of the AC motor by controlling an inverter based on a detection signal of the rotational position sensor.

As a technique for controlling an AC motor, JP-A-2006-311770 discloses a method that can restrict a change in torque at a time when a pulse width modulation (PWM) control mode and a rectangular wave control mode are changed in accordance with operating conditions of an AC motor.

JP-A-2006-074951 discloses a method that can restrict an offset of electric current in a rectangular wave control by reducing a difference in a switching timing of an inverter due to a detection error of a position detector such as a resolver.

US 2008/0197800 A (corresponding to JP-A-2008-206391) discloses a control architecture that includes a stationary frame current (normal current) regulator and a synchronous frame current (offset current) regulator in order to restrict an offset current (subharmonic wave component), and the control architecture can drive the AC motor with a high efficiency.

In general, a control circuit of an AC motor is formed of a microcomputer. The control circuit determines an electrical angle of the AC motor based on a rotational position signal (digital signal) that is obtained by digitizing a detection signal (analog signal) of a rotational position sensor with an R/D converter. The microcomputer basically uses binary numbers. Thus, the control circuit uses a rotational position signal obtained by digitizing the detection signal of the rotational position sensor with a resolution that the quotient when an electrical angle of 360 degrees is divided by (2ⁿ−1), such as 360/(2¹⁰−1) and 360/(2¹²−1), is set to a quantization unit. The quantization unit is analog quantity corresponding to 1 digital unit.

In a case where three-phase rectangular wave voltages are applied to an AC motor in a rectangular wave control of the AC motor, an on/off ratio of each of the rectangular wave voltage is 1:1, that is, a duty ratio of each of the rectangular wave voltages is 50%, and phases of the rectangular wave voltages are different from each other by an electrical angle of 120 degrees, it is required to switch the rectangular wave voltages every electrical angle of 60 degrees so as to commutate an energizing current of the AC motor every electrical angle of 60 degrees. When the control circuit uses a rotational position signal obtained by digitizing the detection signal of the rotational position sensor with a resolution that the quotient when an electrical angle of 360 degrees is divided, for example, by (2¹⁰−1) or (2¹²−1) is set to a quantization unit, the electrical angle of 60 degrees is not an integral multiple of the quantization unit. Thus, the control circuit is difficult to determine the electrical angle of 60 degrees by receiving an influence of an error due to the resolution of the rotational position signal, the control circuit is difficult to generate the rectangular wave voltages commutated every electrical angle of 60 degrees, and the control circuit is difficult to perform the rectangular wave control with a high degree of accuracy. As a result, an offset of electric current flowing to the AC motor may occur, and a torque control accuracy of the AC motor may be reduced.

### SUMMARY OF THE INVENTION

In view of the foregoing problems, it is an object of the present invention to provide an alternating current motor system that can perform a rectangular wave control with a high degree of accuracy based on a rotational position signal obtained by digitizing a detection signal of a rotational position sensor.

An alternating current motor control system according to an aspect of the present invention includes a three-phase synchronous alternating current motor, a rotational position sensor, and a motor control portion. The three-phase synchronous alternating current motor includes a rotor. The rotational position sensor detects a rotational position of the rotor. The motor control portion digitizes a detection signal of the rotational position sensor into a rotational position signal with a resolution that a quotient when an electrical angle of 360 degrees is divided by a multiple of 3 is set to a quantization unit. The motor control portion performs a rectangular wave control of applying a rectangular wave voltage based on the rotational position signal so that an energizing current of the three-phase synchronous alternating current motor is commutated every electrical angle of 60 degrees.

In the alternating current motor control system, the rotational position signal is obtained by digitizing the detection signal of the rotational position sensor with the resolution that the quotient when the electrical angle of 360 degrees is divided by the multiple of 3 is set to the quantization unit. Thus, the electrical angle of 60 degrees can be an integral multiple of the quantization unit. Therefore, the motor control portion can determine the electrical angle of 60 degrees with a high degree of accuracy without being influenced by an error of the rotational position signal and can perform the rectangular wave control with a high degree of accuracy.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is a block diagram showing a motor control system according to an embodiment of the present invention;

FIG. 2 is a graph showing a relationship between an electrical angle “θe” corresponding to a detection signal of a rotational position sensor and a sample electrical angle “θes”; and

FIG. 3 is a timing diagram showing a rectangular wave control in which a rectangular wave voltage is commutated every electrical angle of 60 degrees.

### DETAILED DESCRIPTION OF THE PREFERRED EMBODIMENTS

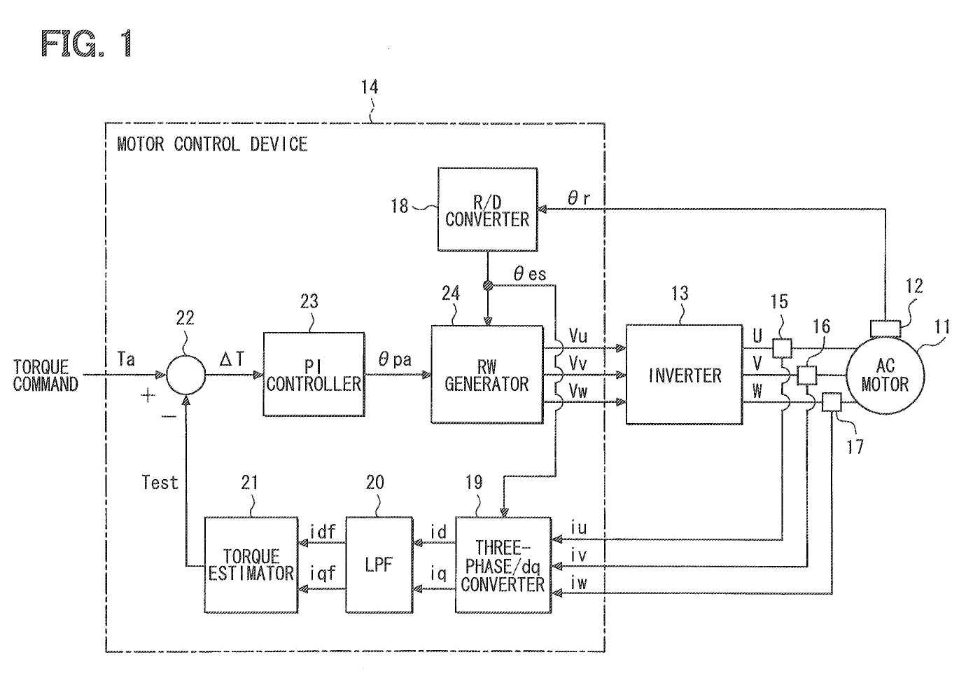

A motor control system according to an embodiment of the present invention will be described with reference to FIG. 1. The motor control system can be applied, for example, to an electric vehicle or a hybrid vehicle that uses an alternating current motor as a source of power. The motor control system includes an alternating current (AC) motor 11. The AC motor 11 is a three-phase permanent magnet synchronous motor used as a source of power of a vehicle. The AC motor 11 includes a permanent magnet. A rotational position sensor 12 for detecting a rotational position of a rotor is mounted to the AC motor 11. The AC motor 11 is driven by a voltage-controlled three-phase inverter 13. Based on three-phase voltage command signals “Vu,” “Vv,” and “Vm” output from a motor control device 14, the inverter 13 converts a direct current voltage supplied from a direct current power source (not shown) such as a secondary battery into three-phase alternating current voltages “U,” “V,” and “W” and drives the AC motor 11.

A U-phase current “iu,” a V-phase current “iv,” and a W-phase current “iw” that flow in respective phases of the AC motor 11 are detected by electric current sensors 15-17, respectively. Alternatively, electric currents that flow in two phases of the AC motor 11 may be detected by respective electric current sensors and electric current that flows in the other phase may be calculated from the detected electric currents.

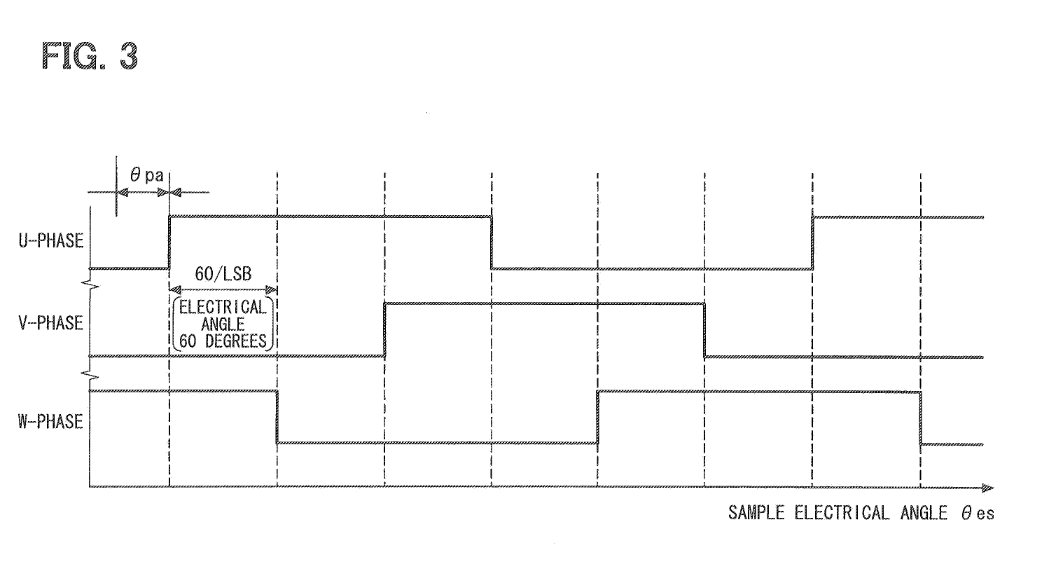

When the motor control device 14 performs a torque control of the AC motor 11, the motor control device 14 generates the three-phase command signals “Vu,” “Vv,” and “Vw” by a rectangular wave control method based on a torque command “Ta,” the U-phase current “iu,” the V-phase current “iv,” the W-phase current “iw,” and a detection signal “θr” of the rotational position sensor 12. In the rectangular wave control, as shown in FIG. 3, rectangular wave voltages applied to the AC motor 11 are commutated every electrical angle of 60 degrees so that an on/off ratio of each of the rectangular wave voltages is 1:1, that is, a duty ratio of each of the rectangular wave voltages is 50%, and phases of the rectangular wave voltages are different from each other by an electrical angle of 120 degrees.

The motor control device 14 includes a resolver-digital (R/D) converter 18, a three-phase/dq converter 19, a low pass filter (LPF) 20, a torque estimator 21, a deviation calculator 22, a proportional-integral (PI) controller 23, and a rectangular wave (RW) generator 24.

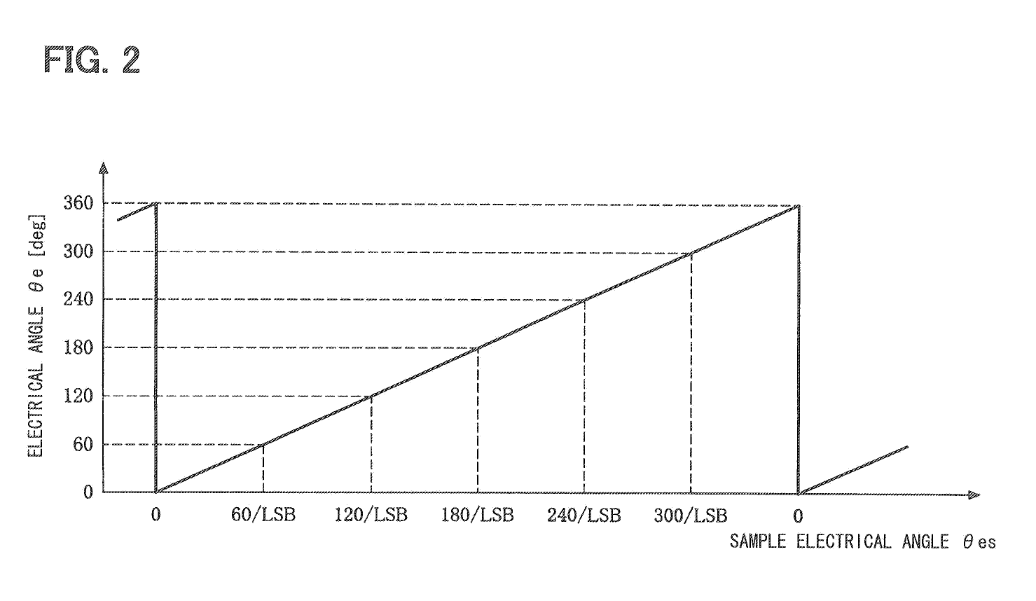

When the motor control device 14 generates the three-phase voltage command signals “Vu,” “Vv,” and “Vw” by the rectangular wave control method, the R/D converter 18 digitizes the detection signal “θr” of the rotational position sensor 12 into a sample electrical angle “θes.” In this case, as shown in FIG. 2, the RID converter 18 converts an electrical angle “θe” corresponding to the detection signal “θr” of the rotational position sensor 12 into the sample electrical angle “θes” with a resolution that the quotient when an electrical angle of 360 degrees is divided by 3×2ⁿ is set to a quantization unit LSB, that is, LSB=360/(3×2ⁿ), where “n” is an integral number greater than or equal to 1 and is set so that a sufficient resolution is secured. For example, “n” may be an integral number from 10 to 12. A sample electrical angle θes=60/LSB corresponds to an electrical angle θe=60.

Then, as shown in FIG. 1, the three-phase/dq converter 19 calculates a d-axis current “id” and a q-axis current “iq” in a d-q coordinate system that is set as a rotating coordinate of the rotor of the AC motor 11 with a map or an expression based on the U-phase current “iu,” the V-phase current “iv,” the W-phase current “iw,” and the sample electrical angle “θes.”

The three-phase/dq converter 19 inputs the d-axis current “id” and the q-axis current “iq” to the low pass filter 20. The low pass filter 20 allows passages of only a low-frequency component of the d-axis current “id” and only a low-frequency component of the q-axis current “iq” so as to attenuate a harmonic wave current component of the AC motor 11 and extract a d-axis component and a q-axis component of a fundamental wave current, that is, a d-axis current “idf” and a q-axis current “iqf.”

The torque estimator 21 calculates a torque estimate “Test” of the AC motor 11 with a map or an expression based on the d-axis current “idf” and the q-axis current “idf.” The torque estimator 21 may calculate the torque estimate “Test”, for example, from the following expression with the number of pairs of poles “pn” of the AC motor 11, a flux linkage “ke,” a d-axis inductance “Ld,” and a q-axis inductance “Lq.”

Test=pn×{ke×idf+(Ld−Lq)×idf×iqf}

Then, the deviation calculator 22 calculates a deviation “ΔT” of the torque command “Ta” and the torque estimate “Test.” The deviation calculator 22 inputs the deviation “ΔT” into the PI controller 23. The PI controller 23 calculates a phase command “θpa” of a rectangular wave voltage so that the deviation “ΔT” of the torque command “Ta” and the torque estimate “Test” becomes small. The PI controller 23 may calculate the phase command “θpa,” for example, from the following expression.

θpa=Kp×ΔT+Ki×∫(ΔT)dt

where, “Kp” is a proportional gain and “Ki” is an integral gain.

The phase command “θpa” is a phase from a predetermined electrical angle position of the AC motor 11. The phase command “θpa” may be a phase determined with reference to the d-axis or the q-axis.

The RW generator 24 determines the electrical angle “θe” based on the sample electrical angle “θes” obtained by digitizing the detection signal “θr” of the rotational position sensor 12. Then, the RW generator 24 generates a U-phase rectangular wave voltage, a V-phase rectangular wave voltage, a W-phase rectangular wave voltage. The U-phase rectangular wave voltage is ahead of a reference electrical angle “θ0” by the phase command “θpa,” and a duty ratio of the U-phase rectangular wave voltage is 50%. The V-phase rectangular wave voltage is ahead of the U-phase rectangular wave voltage by an electrical angle of 120 degrees, and a duty ratio of the V-phase rectangular wave voltage is 50%. The W-phase rectangular wave voltage is ahead of the V-phase rectangular wave voltage by an electrical angle of 120 degrees, and a duty ratio of the W-phase rectangular wave voltage is 50%. The RW generator 24 also generates the three-phase voltage command signals “Vu,” “Vv,” and “Vw” so that the rectangular wave voltages are commutated every electrical angle of 60 degrees, that is, the sample electrical angle of 60/LSB.

As described above, in the rectangular wave control, the motor control device 14 determines the electrical angle “θe” based on the sample electrical angle “θes” and commutates the rectangular wave voltages applied to the AC motor 11 every electrical angle of 60 degrees. Because the motor control device 14 uses the sample electrical angle “θes” obtained by digitizing the detection signal “θr” of the rotational position sensor 12 with the resolution that the quotient when the electrical angle of 360 degrees is divided by 3×2ⁿ is set to the quantization unit LSB, that is, LSB=360/(3×2ⁿ), the electrical angle of 60 degrees can be an integral multiple of the quantization unit LSB. Thus, the motor control device 14 can determine the electrical angle 60 degrees with a high degree of accuracy without being influenced by an error of the sample electrical angle “θes” and the motor control device 14 can commutate the rectangular wave voltages every electrical angle of 60 degrees with a high degree of accuracy. Therefore, an offset of an electric current of the AC motor 11 can be restricted and a torque control accuracy of the AC motor 11 can be improved.

In the above-described embodiment, the detection signal of the rotational position sensor 12 is digitized with the resolution that the quotient when the electrical angle 360 degrees is divided by 3×2ⁿ is set to the quantization unit LSB. The detection signal of the rotational position sensor 12 may also be digitized with a resolution that the quotient when the electrical angle 360 degrees is divided by a multiple of 3 (for example, a multiple of 6) is set to the quantization unit LSB.

In the above-described embodiment, the motor control device 14 includes the R/D converter 18 that digitizes the detection signal of the rotational position sensor 12. Alternatively, the rotational position sensor 12 may include a function that digitizes the detection signal of the rotational position sensor 12.

The motor control system can be used for controlling any AC motor without being limited to an AC motor mounted on an electric vehicle or a hybrid vehicle.

What is claimed is:

1. An alternating current motor control system comprising:
a three-phase synchronous alternating current motor including a rotor;
a rotational position sensor configured to detect a rotational position of the rotor; and
a motor control portion configured to digitize a detection signal of the rotational position sensor into a rotational position signal with a resolution that a quotient when an electrical angle of 360 degrees is divided by a multiple of 3 is set to a quantization unit, the motor control portion configured to perform a rectangular wave control of applying a rectangular wave voltage based on the rotational position signal so that an energizing current of the three-phase synchronous alternating current motor is commutated every electrical angle of 60 degrees.

2. The alternating current motor control system according to claim 1, wherein
the motor control portion digitizes the detection signal of the rotational position sensor into the rotation position signal with a resolution that a quotient when an electrical angle of 360 degrees is divided by 3×2ⁿ is set to the quantization unit, where “n” is an integral number greater than or equal to 1.
